(19) United States
(12) Patent Application Publication
(10) Pub. No.: US 2010/0271693 A1
(43) Pub. Date: Oct. 28, 2010

(54) NARROWBAND FILTERS FOR THE EXTREME ULTRAVIOLET

(76) Inventors: Manuela Vidal Dasilva, Madrid (ES); Mónica Fernandez Perea, Madrid (ES); Juan Ignacio Larruquert Goicoechea, Madrid (ES); José Antonio Mendez Morales, Madrid (ES); José Antonio Aznarez Candao, Madrid (ES); José María Sanchez Orejuela, Madrid (ES)

Correspondence Address: IP Patent Docketing;K&L GATES LLP, 599 Lexington Avenue, 33rd Floor, New York, NY, 10022-6030, US

(21) Appl. No.: 12/429,944

(22) Filed: Apr. 24, 2009

(51) Int. Cl. G02B 5/20

(52) U.S. Cl. 359/360

(57) ABSTRACT

A filter for extreme ultraviolet is disclosed. The filter may be formed by a multilayer structure comprising several layers of Yb and Al deposited on a substrate using thermal evaporation. The layers of Yb and Al may be separated by SiO layers, which may act as barriers avoiding interaction between the layers. The multilayer structure may be covered by a SiO protective layer.

### BACKGROUND

The optical properties of materials in the EUV are characterized by the fact that transparency decreases progressively as the LiF cutoff wavelength (105 nm) is approached, both from longer and shorter wavelengths. When approaching it from longer wavelengths, the cutoff abruptly separates transparency from strong absorption, whereas absorption decreases slowly short of the LiF cutoff. This edge will be considered here as the separation between far ultraviolet (FUV, 105-200 nm) and extreme ultraviolet (EUV, 50-105 nm). The limited transparency of materials near the LiF cutoff implies that the performance of optical coatings is less efficient than it is far above this edge, where there is a wealth of transparent materials with refractive indices almost at choice, but also far below this same edge, where low absorbing materials are available to alternate in multilayers well tuned at the desired wavelength. Additionally, the strong absorption of adsorbed air molecules and of the thin layers of compounds formed on the surface of many materials after air exposure makes necessary the in situ characterization of the optical properties of materials (before any exposure to the atmosphere takes place) and a through study of coating ageing.

Optical coatings are used for imaging purposes of the atmosphere, the solar system or the galaxy. These kind of coatings are suitable for capturing images of the radiation emitted, for instance, by the OII ions from the higher layers of the atmosphere, which is a tracer of the electronic density, and an important parameter used to explain the dynamics of the ionosphere and the magnetosphere.

The main problem found when developing these measurements is that emissions from the OII come along with other contributions from other species in gaseous state, such as emission lines of HeII in 30.4 nm, HeI in 58.4 nm, OI in 98.9 nm, HI in 102.6 nm; and, above all, the Lyman-alpha line of H, whose intensity can be twice the amount of that of the line of OII.

Several designs were proposed and developed, said designs were trying to get a high reflectance in the line of OII at 83.4 nm and a low reflectance in the Lyman-alpha line of H at 121.6 nm, without taking into account the dependency of said reflectance with the wavelength of the rest of the range FUV/EUV.

Those filters consisted of three layers of Al, MgF2 and Ni or Al, MgF2 and Mo (from the substrate to the outer layer). Chakrabarti et al. also designed and developed a filter based on a three layers design; said layers were listed as Al, In and SiO2, this filter rendered negative results.

Edelstein designed several coatings as well, his objective was similar to the earlier referred aim cited in previous studies, except for the fact that the wavelength of the maximum reflectance was that of the line 102.6 nm of HI. Said coatings consisted of an inner layer of Al, a second layer of LiF and an external layer of SiO2, Al2O3 or Au. The author also proposed a five layers filter, said layers were made of Al, LiF, Si, LiF and SiO2; but this filter was never developed.

Seely and Hunter proposed similar coatings, said coatings when combined with a transmission filter and an interferential photocathode presented a narrowband around 83.4 nm. This work was pointing to coatings which were never developed, though. The proposed reflectance filter consisted of three layers of Al, MgF2 and Si or SiC.

Narrowband filters for reflection working within the range delimited between 50 and 105 nm are not common. Windt et al. designed and prepared multilayer filters. Filters comprised several layers, composed of Tb and Si or Tb and SiC, which were tuned in order to obtain a maximum reflectance at about 60 nm.

Seely et al. developed multilayer structures of B4C/La, Si/Tb and SiC/Tb centered at 92.5 nm for the first case and at around 60 nm for the last two cases. Multilayers centered at 92.5 nm demonstrated a reflectance at the peak of the order of 10%.

Kjornrattanawanich et al. also developed multilayer structures of Si/Nd and Si/Gd intended for obtaining maximum reflectance at around 60 nm. Furthermore, they deposited layers of material separated by barriers consisting of layers of Si3N4 and B4C of 0.5 and 1.5 nm thick in order to avoid material diffusion between the layers separated by said barriers.

### DETAILED DESCRIPTION OF EXAMPLE EMBODIMENTS

Some example embodiments of the present invention are narrowband filters intended for use in imaging applications in the extreme UV range, Such filters have a multilayer structure.

Some of these narrowband filters are intended for wavelengths in the range of the EUV, in the vicinity of 80 nm. Some example embodiments of the present invention may include a novel coating compositions which can reflect narrow bands at said wavelengths, which are not covered by any other filter found in previous studies.

The above mentioned coatings may include three layers of different materials which have sequentially been deposited on a stable substrate using thermal evaporation in ultra-high vacuum conditions. These materials have been chosen from the variety of suitable materials for such purposes, taking into account their chemical and optical properties. Moreover the example filter described here may use a combination of coatings of three different materials (Yb, Al and SiO) in order to create a multilayer structure which determines the narrowband filter.

Yb layers have not been previously used for coatings in narrowband filters. The Yb layers described here render high performance values in EUV ranges when multiple layers of Yb are combined with Al layers. In order to form the filter, deposited Yb and Al layers may be separated by SiO layers forming a multilayer structure on a substrate.

SiO layers may act as borders or barriers since Yb and Al are quite reactive materials. Providing a separation layer or barrier-layer between both materials may avoid interaction or atomic transfers between the layers.

The use of the earlier mentioned barrier-layers is intended for isolating the materials formed in the layers which are actually separated by the barrier-layers, preventing the interaction of both materials and avoiding the formation of dendritic structures in the layers.

The multilayer structure may include several layers of material which may have different thicknesses. Layer thicknesses were assessed using computer models, such as Monte Carlo simulation. Simulation was first carried out for every layer and the layers were then deposited and grown according to the parameters output by the simulation. Once the designed filter was finished, real experiments were carried out in order to validate the values given by the simulation.

The filter can be tuned in frequencies between 75 and 95 nm by varying the thickness of the outermost layer of Yb (from 11 to 40 nm). Depending on the values for the parameter of thickness, the filter can render values of 10-15 nm in FWHM and from about 0.10 to 0.20 in reflectance at its maximum.

The whole multilayer structure may covered by a layer of SiO. This external layer may prevent external damage to the filter.

### EXAMPLE

In an example, layers of Yb, Al and SiO were formed by vacuum deposition. The deposition was carried out using PVD techniques. Using these techniques, the materials were sequentially deposited on the substrate, forming the layers, and rendering the multilayer structure. Amongst all the PVD techniques, thermal evaporation deposition was selected, although it will be appreciated that other PVD techniques, and other depositions techniques may also be employed. In thermal evaporation the material to be evaporated is placed on an evaporation tray or evaporation source, then an electrical current is driven though said source. Due to this electrical current running through the source, a Joule effect is generated and both the tray and the material are heated up to the desired temperature. The temperature is regulated by controlling the voltage levels of the electrical current.

Considering that the multilayer structure is formed by layers comprising three different materials, a flange with three electrical passages was placed in the evaporation chamber.

Next, an evaporation source was placed in every single passage of the flange, one evaporation source per each material. For the Al layer, the source was formed by several straight wires of W. The wires were interconnected by a small amount of melted Al. For the rest of the materials, a box shaped source of Ta was used. The materials forming the sources had a purity level of 99.999% in the case of Al, 99.9% for the Yb and 99.97% for the SiO.

As an example of the coating realization, during the deposition processes the distance between the sources and the substrate was set to 38 cm.; and the evaporation rate was set between 1.5 and 6.0 nm/s for Al, between 0.2 and 0.6 nm/s for Yb and between 0.05 and 0.08 nm/s for SiO. The pressure levels reached during the evaporation processes were as follows, for Al deposition a pressure level between 10⁻⁸ and 6×10⁻⁸ mbar was reached, for Yb a pressure level between 10⁻⁷ and 5×10⁻⁷ mbar was reached and for the SiO a pressure between 2×10⁻⁹ and 2×10⁻⁸ mbar was reached.

In some example embodiments, the size/thickness of every layer of the multilayer structure formed by the earlier cited processes was defined by a thickness control carried out using quartz microbalances during the preparation of the samples. This control gave an overview or forecast of the final real value of the thickness of the layer, which would be checked after each deposition. The check or thickness control of each layer was carried out by extracting each sample from the vacuum chamber and using the interferometric technique developed by Tolansky. These interferometric techniques were also used to calibrate the quartz microbalances.

### MODIFICATIONS

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A narrowband filter for the extreme ultraviolet range, comprising:
at least an innermost layer of Yb, a layer of Al and an outermost layer of Yb deposited on a support and forming a multilayer structure;
a protecting layer covering the multilayer structure; and
barrier layers separating the layers of Yb and Al.

2. The narrowband filter of claim 1, wherein the protecting layer comprises SiO.

3. The narrowband filter of claim 2, wherein the thickness of the barrier layers of SiO is of at least 1.0 nm.

4. The narrowband filter of claim 1, wherein the thickness of the protecting layer is at least 7 nm.

5. The narrowband filter of claim 1 wherein the thickness of the outermost layer of Yb has is between 11 and 40 nm and wherein the filter provides maximum values of reflectance in the range of wavelengths between 75 and 95 nm.

6. The narrowband filter of claim 1 wherein the thickness of the layer of Al is between 5 nm and 200 nm.

7. The narrowband filter of claim 1, wherein
the protecting layer comprises SiO having a thickness of at least 7.0 nm,
the barrier layers comprise SiO having a thickness of at least 1.0 nm,
the thickness of the layer of Al is between 5 nm and 200 nm
the thickness of the outermost layer of Yb is between 11 and 40 nm; and
wherein the filter provides maximum values of reflectance in the range of wavelengths between 75 and 95 nm.
